(19) United States
(12) Patent Application Publication
(10) Pub. No.: US 2025/0274854 A1
(43) Pub. Date: Aug. 28, 2025

(54) METHOD, DEVICE AND COMPUTER STORAGE MEDIUM OF COMMUNICATION

(71) Applicant: NEC Corporation, Tokyo (JP)

(72) Inventor: Gang WANG, Beijing (CN)

(73) Assignee: NEC Corporation, Tokyo (JP)

(21) Appl. No.: 18/857,928

(22) PCT Filed: Apr. 22, 2022
(86) PCT No.: PCT/CN2022/088428

§ 371 Date: Oct. 18, 2024

(51) Int. Cl. H04W 48/20; H04W 4/06; H04W 74/0833

(52) U.S. Cl. CPC H04W 48/20; H04W 4/06; H04W 74/0833

(57) ABSTRACT

Embodiments of the present disclosure relate to methods, devices and computer readable media for communication. If a terminal device is to perform a multicast reception in an inactive or idle state, the terminal device transmits, to a network device, a first message comprising a preference on the multicast reception in the inactive or idle state, and receives, from the network device, a second message indicating the multicast reception in the inactive or idle state and comprising a multicast configuration for the multicast reception. Then the terminal device performs the multicast reception in the inactive or idle state based on the multicast configuration. In this way, a terminal device may precisely or reasonably enter an inactive or idle state to receive a multicast service. Further, the terminal device may receive a multicast configuration to make sure the service continuity upon cell reselection.

### TECHNICAL FIELD

Embodiments of the present disclosure generally relate to the field of telecommunication, and in particular, to methods, devices and computer storage media of communication for multicast and broadcast service (MBS).

### BACKGROUND

To enable resource-efficient delivery of MBS, the third generation partnership project (3GPP) has developed new radio (NR) broadcast and multicast in Release 17. In Release 17, multicast is only specified for user equipment (UE) in a connected state, which may not fully fulfil requirements of some services (e.g., mission critical services) especially for cells with a large number of UEs. In addition, to always keep UEs in a connected state is not power efficient. It is therefore important to support multicast for UEs in an inactive state. However, solutions of multicast reception in an inactive state are still incomplete and need to be further developed.

### SUMMARY

In general, embodiments of the present disclosure provide methods, devices and computer storage media of communication for a multicast reception in an inactive or idle state.

In a first aspect, there is provided a method of communication. The method comprises: in accordance with a determination that a terminal device is to perform a multicast reception in an inactive or idle state, transmitting, at the terminal device and to a network device, a first message comprising a preference on the multicast reception in the inactive or idle state; receiving, from the network device, a second message indicating the multicast reception in the inactive or idle state and comprising a multicast configuration for the multicast reception; and performing the multicast reception in the inactive or idle state based on the multicast configuration.

In a second aspect, there is provided a method of communication. The method comprises: receiving, at a terminal device in a connected state and from a network device, a third message comprising a multicast configuration for multicast reception of the terminal device in an inactive or idle state; and in accordance with a determination that the terminal device is to perform the multicast reception in the inactive or idle state, performing the multicast reception in the inactive or idle state based on the multicast configuration.

In a third aspect, there is provided a method of communication. The method comprises: receiving, at a terminal device and from a network device, a fourth message indicating multicast reception in an inactive or idle state and comprising a multicast configuration for the multicast reception, the multicast configuration comprising at least one of the following: an indication of the multicast reception in the inactive or idle state, a list of multicast configurations specific to the terminal device for cell reselection, or a multicast frequency priority for cell reselection; and performing the multicast reception in the inactive or idle state based on the multicast configuration.

In a fourth aspect, there is provided a method of communication. The method comprises: receiving, at a network device and from a terminal device, a first message comprising a preference on a multicast reception in an inactive or idle state; transmitting, to the terminal device, a second message indicating the multicast reception in the inactive or idle state and comprising a multicast configuration for the multicast reception.

In a fifth aspect, there is provided a method of communication. The method comprises: generating, at a network device, a multicast configuration for multicast reception of a terminal device in an inactive or idle state; and transmitting, to the terminal device in a connected state, a third message comprising the multicast configuration.

In a sixth aspect, there is provided a method of communication. The method comprises: generating, at a network device, a multicast configuration for a multicast reception of a terminal device in an inactive or idle state, the multicast configuration comprising at least one of the following: an indication of the multicast reception in the inactive or idle state, a list of multicast configurations specific to the terminal device for cell reselection, or a multicast frequency priority for cell reselection; and transmitting, to the terminal device, a fourth message indicating the multicast reception of the terminal device in the inactive or idle state and comprising the multicast configuration.

In a seventh aspect, there is provided a terminal device. The terminal device comprises a processor configured to cause the terminal device to perform the method according to any of the first to third aspects of the present disclosure.

In an eighth aspect, there is provided a network device. The network device comprises a processor configured to cause the network device to perform the method according to any of the fourth to sixth aspects of the present disclosure.

In a ninth aspect, there is provided a computer readable medium having instructions stored thereon. The instructions, when executed on at least one processor, cause the at least one processor to perform the method according to any of the first to third aspects of the present disclosure.

In a tenth aspect, there is provided a computer readable medium having instructions stored thereon. The instructions, when executed on at least one processor, cause the at least one processor to perform the method according to any of the fourth to sixth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2A illustrates a schematic diagram of a unicast scenario in which some embodiments of the present disclosure can be implemented;

FIG. 2B illustrates a schematic diagram of a multicast scenario in which some embodiments of the present disclosure can be implemented;

FIG. 3 illustrates a schematic diagram illustrating a process of communication for performing a multicast reception based on a UE request according to embodiments of the present disclosure;

FIG. 4A illustrates a schematic diagram illustrating an example data transmission according to embodiments of the present disclosure;

FIG. 4B illustrates a schematic diagram illustrating another example data transmission according to embodiments of the present disclosure;

FIG. 5 illustrates a schematic diagram illustrating a process of communication for performing a multicast reception based on a network indication according to embodiments of the present disclosure;

FIG. 6 illustrates a schematic diagram illustrating a process of communication for performing a multicast reception based on a predefined configuration according to embodiments of the present disclosure;

FIG. 7A illustrates a schematic diagram illustrating a process of communication for skipping a multicast paging according to embodiments of the present disclosure;

FIG. 7B illustrates a schematic diagram illustrating a process of communication for entering a connected state for multicast reception according to embodiments of the present disclosure;

FIG. 7C illustrates a schematic diagram illustrating another process of communication for entering a connected state for multicast reception according to embodiments of the present disclosure;

FIG. 7D illustrates a schematic diagram illustrating still another process of communication for entering a connected state for multicast reception according to embodiments of the present disclosure;

FIG. 8 illustrates an example method of communication implemented at a terminal device in accordance with some embodiments of the present disclosure;

FIG. 9 illustrates another example method of communication implemented at a terminal device in accordance with some embodiments of the present disclosure;

FIG. 10 illustrates still another example method of communication implemented at a terminal device in accordance with some embodiments of the present disclosure;

FIG. 11 illustrates an example method of communication implemented at a network device in accordance with some embodiments of the present disclosure;

FIG. 12 illustrates another example method of communication implemented at a network device in accordance with some embodiments of the present disclosure;

FIG. 13 illustrates still another example method of communication implemented at a network device in accordance with some embodiments of the present disclosure; and

FIG. 14 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “MBS” may be interchangeably used with “multicast”, “multicast service”, “multicast transmission” or “multicast data”. The term “multicast reception” may be interchangeably used with “MBS reception”. The term “a connected state” may be interchangeably used with “a RRC_CONNECTED state”, the term “an idle state” may be interchangeably used with “a RRC_IDLE state”, and the term “an inactive state” may be interchangeably used with “a RRC_INACTIVE state”.

Currently, it has been proposed to support multicast reception by UEs in an inactive state. For example, it has been proposed to support a point to multi-point (PTM) configuration for UEs receiving multicast in an inactive state. It also has been proposed to study impact of mobility and state transition for UEs receiving multicast in an inactive state.

In view of this, embodiments of the present disclosure provide a solution for transitioning between a multicast reception in a connected state and a multicast reception in an inactive or idle state.

In one aspect, in accordance with a determination that a terminal device is to perform a multicast reception in an inactive or idle state, the terminal device transmits, to a network device, a first message comprising a preference on the multicast reception in the inactive or idle state. Upon reception of a second message indicating the multicast reception in the inactive or idle state and comprising a multicast configuration for the multicast reception, the terminal device performs the multicast reception in the inactive or idle state based on the multicast configuration. In this way, a terminal device may precisely or reasonably enter an inactive or idle state to receive a multicast service. Further, the terminal device may receive a multicast configuration to make sure the service continuity upon cell reselection.

In another aspect, a terminal device receives, from a network device, a fourth message indicating a multicast reception in an inactive or idle state and comprising a multicast configuration for the multicast reception. The multicast configuration comprises at least one of the following: an indication of the multicast reception in the inactive or idle state, a list of multicast configurations specific to the terminal device for cell reselection, or a multicast frequency priority for cell reselection. The terminal device performs the multicast reception in the inactive or idle state based on the multicast configuration. In this way, a terminal device is enabled to enter an inactive or idle state in a more flexible way based on network implementation to receive a multicast service.

In still another aspect, a terminal device in a connected state receives, from a network device, a third message comprising a multicast configuration for multicast reception of the terminal device in an inactive or idle state. In accordance with a determination that the terminal device is to perform the multicast reception in the inactive or idle state, the terminal device performs the multicast reception in the inactive or idle state based on the multicast configuration. In this way, a terminal device is enabled to enter an inactive or idle state in a more flexible and fast way based on a predefined multicast configuration to receive a multicast service.

Principles and implementations of the present disclosure will be described in detail below with reference to the figures.

### Example of Communication Network

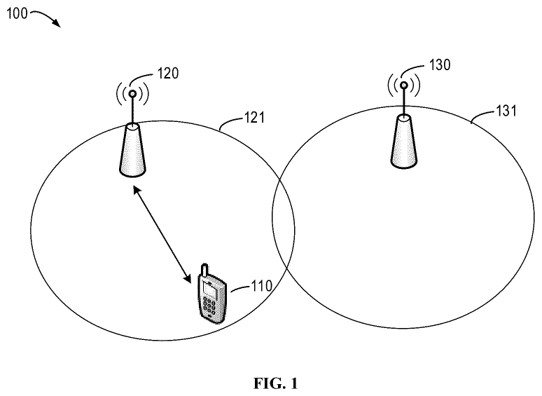

FIG. 1 illustrates a schematic diagram of an example communication network 100 in which some embodiments of the present disclosure can be implemented. As shown in FIG. 1, the communication network 100 may include a terminal device 110, a network device 120, and a network device 130. In some embodiments, the network device 120 may provide a serving cell (also referred to as a cell herein) 121 to serve one or more terminal devices. The network device 130 may also provide a cell 131 to serve one or more terminal devices. In this example, the terminal device 110 is shown as being located in the cell 121 and served by the network device 120.

In some embodiments, as the terminal device 110 moves, the terminal device 110 may reselect from the cell 121 to the cell 131 and then may be served by the network device 130. In some embodiments, the terminal device 110 may perform the cell reselection in an inactive or idle state.

It is to be understood that the number of devices or cells in FIG. 1 is given for the purpose of illustration without suggesting any limitations to the present disclosure. The communication network 100 may include any suitable number of network devices and/or terminal devices and/cells adapted for implementing implementations of the present disclosure.

As shown in FIG. 1, the terminal device 110 may communicate with the network devices 120 and 130 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

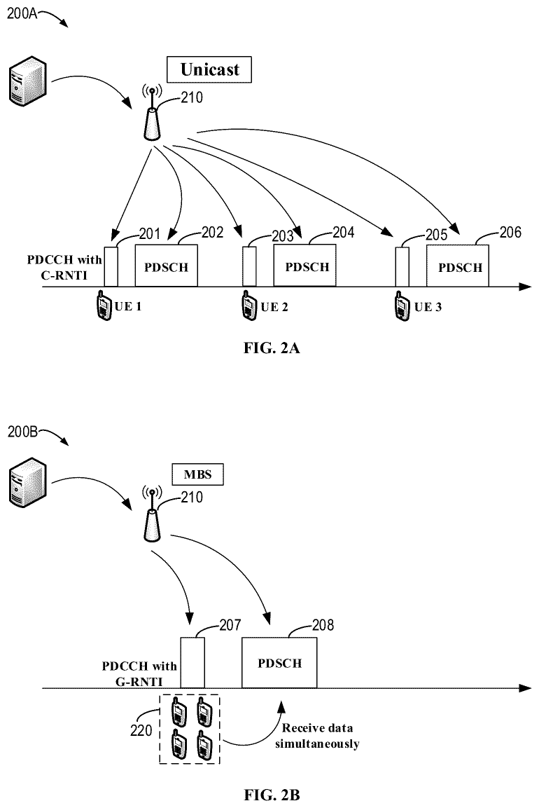

In some embodiments where the terminal device 110 is served by the network device 120, the terminal device 110 may receive a unicast service from the network device 120. FIG. 2A illustrates a schematic diagram of a unicast scenario 200A in which some embodiments of the present disclosure can be implemented. As shown in FIG. 2A, a base station 210 may transmit downlink control information (DCI) on a physical downlink control channel (PDCCH) 201 with a cell-radio network temporary identifier (C-RNTI) for UE1. In this way, UE1 may be scheduled to receive data (for example, video stream) on a physical downlink shared channel (PDSCH) 202 in unicast. Similarly, the base station 210 may transmit DCI on a PDCCH 203 with a C-RNTI for UE2 to schedule UE2 to receive the data on a PDSCH 204 in unicast. The base station 210 may transmit DCI on a PDCCH 205 with a C-RNTI for UE3 to schedule UE3 to receive the data on a PDSCH 206 in unicast.

In some embodiments where the terminal device 110 is served by the network device 120, the terminal device 110 may receive a multicast service from the network device 120. FIG. 2B illustrates a schematic diagram of a multicast scenario 200B in which some embodiments of the present disclosure can be implemented. As shown in FIG. 2B, the base station 210 may transmit DCI on a PDCCH 207 with a group-radio network temporary identifier (G-RNTI) for a set of UEs 220. In this way, the set of UEs 220 may be scheduled to receive the data on a PDSCH 208 in multicast, i.e., to receive the data simultaneously.

That is, for multicast communication service, the same service and the same specific content data are provided simultaneously to a dedicated set of UEs (i.e., not all UEs in the multicast service area are authorized to receive the data). A multicast communication service is delivered to the UEs using a multicast session. A UE can receive a multicast communication service in a connected state with mechanisms such as point-to-point (PTP) and/or PTM delivery.

In some embodiments, the terminal device 110 may receive data of MBS multicast session only in a connected state. If the terminal device 110 which joined a multicast session is in a connected state and when the multicast session starts, the network device 120 may transmit a radio resource control (RRC) reconfiguration message with relevant MBS configuration (also referred to as a multicast configuration) for the multicast session to the terminal device 110. In this case, there is no need for separate session activation notification for the terminal device 110.

In some embodiments, when there is no data to be sent to the terminal device 110 for a multicast session, the network device 120 may cause the terminal device 110 to enter an inactive or idle state. In some embodiments, when a multicast session has been activated by a core network (CN) or the network device 120 has multicast session data to delivery, the network device 120 may use a group notification mechanism (i.e., multicast paging) to notify the terminal device 110 in an inactive or idle state.

It has been proposed that a terminal device may enter an inactive or idle state to continue receiving multicast service. However, how to trigger a terminal device entering the inactive or idle state is still unclear. When a cell reselection occurs, how the terminal device in the inactive or idle state gets a multicast configuration and monitors a multicast paging are also unclear.

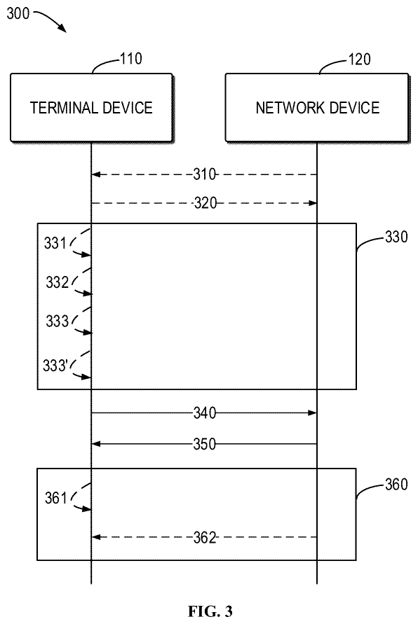

In view of this, embodiments of the present disclosure provide solutions for multicast reception in an inactive or idle state. The detailed description will be made with reference to FIGS. 3 to 7D below.

### Example of Entering Inactive or Idle State Based on Ue Request

In this embodiment, a terminal device may enter, based on its request (i.e., UE request), an inactive or idle state to continue receiving multicast service.

FIG. 3 illustrates a schematic diagram illustrating a process 300 of communication according to embodiments of the present disclosure. For the purpose of discussion, the process 300 will be described with reference to FIG. 1. The process 300 may involve the terminal device 110 and the network device 120 as illustrated in FIG. 1. It is to be understood that the steps and the order of the steps in FIG. 3 are merely for illustration, and not for limitation. For example, the order of the steps may be changed. Some of the steps may be omitted or any other suitable additional steps may be added. It is assumed that the terminal device 110 is served by the network device 120 and the terminal device 110 is in a connected state initially.

As shown in FIG. 3, the network device 120 may transmit 310, to the terminal device 110, an enquiry for a capability of the terminal device 110. For example, the network device 120 may transmit a UECapabilityEnquiry message or any other suitable messages. In response to the enquiry, the terminal device 110 may transmit 320, to the network device 120, the capability of the terminal device 110 for the multicast reception in the inactive or idle state. For example, the terminal device 110 may transmit a UECapabilityInformation message or any other suitable messages. In some embodiments, the capability of the terminal device 110 may indicate whether to support a multicast reception in an inactive or idle state. It is to be understood that the capability of the terminal device 110 may also comprise any other suitable information, and the present disclosure does not limit this aspect.

Continue to refer to FIG. 3, the terminal device 110 may determine 330 whether to perform a multicast reception in an inactive or idle state. In some embodiments, the terminal device 110 may determine whether to perform the multicast reception in the inactive or idle state based on a timer (also referred to as a first timer or a multicast timer herein).

In some embodiments, the network device 120 may configure the multicast timer to the terminal device 110 by a RRC dedicated signaling. In some embodiments, the network device 120 may configure the multicast timer in a system information block (SIB). In some embodiments, the multicast timer may be predefined.

In some embodiments, if multicast data is received and the multicast timer is not running, the terminal device 110 may start 331 the multicast timer. For example, if any medium access control (MAC) entity receives a MAC service data unit (SDU) for MBS traffic channel (MTCH) logical channel for multicast service and if the multicast timer is not running, the terminal device 110 may start the multicast timer.

In some embodiments, if unicast data is received, the terminal device 110 may restart 332 the multicast timer. For example, if any MAC entity receives a MAC SDU for dedicated traffic channel (DTCH), dedicated control channel (DCCH), or common control channel (CCCH) logical channel, the terminal device 110 may restart the multicast timer. In some alternative or additional embodiments, if unicast data is transmitted, the terminal device 110 may restart the multicast timer. For example, if any MAC entity transmits a MAC SDU for DTCH, DCCH, or CCCH logical channel, the terminal device 110 may restart the multicast timer.

In some embodiments, if the multicast timer expires, the terminal device 110 may determine 333 that the terminal device 110 is to perform the multicast reception in the inactive or idle state. For example, if the multicast timer expires, the MAC layer of the terminal device 110 may indicate the expiry of the multicast timer to an upper layer (e.g., RRC layer) of the terminal device 110. In some alternative embodiments, if the terminal device 110 is to enter the inactive or idle state to perform the multicast reception and the multicast timer is not running, the terminal device 110 may determine 333′ that the terminal device 110 is to perform the multicast reception in the inactive or idle state.

Continue to refer to FIG. 3, upon determination that the terminal device 110 is to perform a multicast reception in an inactive or idle state, the terminal device 110 may transmit 340, to the network device 120, a message (for convenience, also referred to as a first message herein) comprising a preference on the multicast reception in the inactive or idle state. For example, the first message may be a UE assistance information (UAI) message. It is to be understood that any other suitable messages are also feasible.

For example, upon reception of the expiry of the multicast timer from a lower layer (e.g., MAC layer) of the terminal device 110 while in a connected state, the terminal device 110 may initiate transmission of a UAI message in accordance with multicast reception in an inactive or idle state request to provide preference report. This preference report will notify the network device 120 that the terminal device 110 wants to receive multicast service in an inactive or idle state.

As another example, if the terminal device 110 has a preference on multicast reception in an inactive or idle state and the terminal device 110 did not transmit a UAI message with a multicast preference for this cell before, and if the multicast timer is not running, the terminal device 110 may initiate transmission of a UAI message in accordance with multicast reception in an inactive or idle state request to provide preference report. This preference report will notify the network device 120 that the terminal device 110 wants to receive multicast service in an inactive or idle state.

With reference to FIG. 3, the terminal device 110 may receive 350, from the network device 120, a message (for convenience, also referred to as a second message herein) indicating the multicast reception in the inactive or idle state and comprising a multicast configuration for the multicast reception. For example, the second message may be a RRC release message. It is to be understood that any other suitable messages are also feasible.

In some embodiments, the multicast configuration may comprise an indication indicating the multicast reception in the inactive or idle state. For example, if the indication is configured with true, the terminal device 110 is indicated to receive a multicast service in an inactive or idle state.

In some embodiments, the multicast configuration may comprise a list of multicast configurations for cell reselection. For example, the list of multicast configurations may comprise C-RNTIs for different cells. As another example, the list of multicast configurations may comprise configurations on packet data convergence protocol (PDCP) or radio link control (RLC) or MAC or physical (PHY) or bandwidth part (BWP) for different cells. For example, the MAC configuration list may comprise G-RNTI(s) for different cells.

In some embodiments, the multicast configuration may comprise a multicast frequency priority for cell reselection. In some embodiments, the multicast configuration may comprise a multicast allowed cell list indicating a first set of cells in which the multicast configuration is allowed to be used for the multicast reception. In some embodiments, the multicast configuration may comprise a neighbor cell list indicating a second set of cells, the second set of cells being providing a multicast service that the terminal device is receiving. It is to be understood that the multicast configuration may also comprise any other suitable information.

In some embodiments, upon transmission of the first message (e.g., UAI), the terminal device 110 may start a timer (for convenience, also referred to as a second timer or a RRC release timer herein). The RRC release timer is to ensure a valid duration of a RRC release message. In some embodiments, the terminal device 110 may further disable the multicast timer. That is, the terminal device 110 may stop evaluating a procedure of the multicast timer and UAI.

In some embodiments, if the RRC release timer expires and the terminal device 110 has not yet received the second message (e.g., RRC release message), the terminal device 110 may enable the multicast timer. That is, the terminal device 110 will re-evaluate the multicast timer for probably triggering UAI again. In some embodiments, upon reception of the second message, the terminal device 110 may stop the RRC release timer if configured.

Upon reception of the second message, the terminal device 110 may perform 360 a multicast reception in an inactive or idle state based on the multicast configuration. For example, the terminal device may enter 361 the inactive or idle state and receive 362 a multicast service in the inactive or idle state.

In some embodiments, if the multicast configuration comprises an indication of the multicast reception in the inactive or idle state, the terminal device 110 may continue receiving multicast data in the inactive or idle state. In other words, the terminal device 110 may apply a multicast configuration used for a connected state to receive the multicast data in the inactive or idle state, without releasing the multicast configuration used for the connected state.

In some embodiments, if the multicast configuration comprises a list of multicast configurations for cell reselection and the terminal device 110 reselects to a cell (for convenience, also referred to as a first cell herein), the terminal device 110 may apply a multicast configuration for the first cell in the list of multicast configurations.

In some embodiments, if the multicast configuration comprises a multicast frequency priority for cell reselection, the terminal device 110 may store the multicast frequency priority and perform the cell reselection based on the multicast frequency priority when the terminal device 110 enters an inactive or idle state.

In some embodiments, if the multicast configuration comprises a multicast allowed cell list, the terminal device 110 may apply the multicast configuration for a cell (for convenience, also referred to as a second cell herein) in the multicast allowed cell list when the terminal device 110 reselects to the second cell.

In some embodiments, if the multicast configuration comprises a neighbor cell list, the terminal device 110 may apply and store the neighbor cell list for the multicast reception.

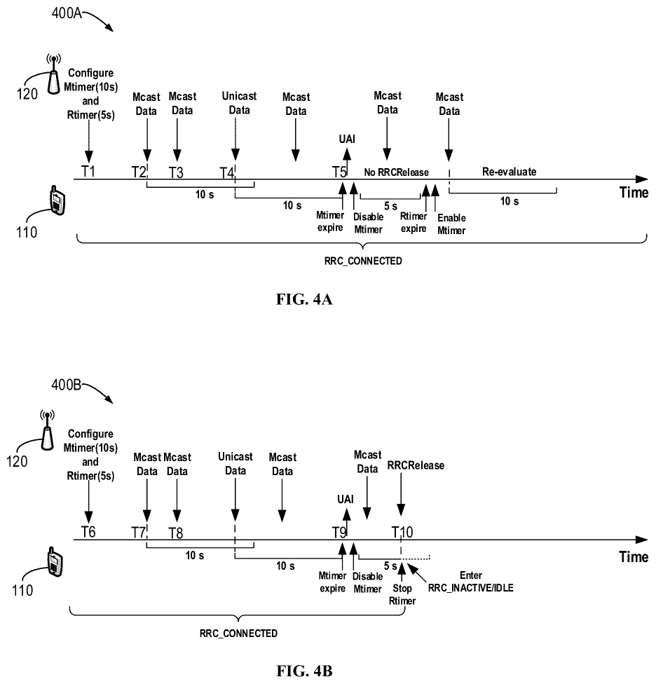

FIG. 4A illustrates a schematic diagram 400A illustrating an example data transmission according to embodiments of the present disclosure. As shown in FIG. 4A, at a timing T1, the network device 120 may configure the terminal device 110 in a connected state with a multicast timer (Mtimer) of 10 s and a RRC release timer (Rtimer) of 5 s. Upon reception of multicast data from the network device 120 at a timing T2, the terminal device 110 may start the multicast timer. During running of the multicast timer, the terminal device 110 may further receive multicast data at a timing T3. In this case, the multicast timer continues running. During running of the multicast timer, the terminal device 110 may receive unicast data at a timing T4. In this case, the multicast timer is restarted. When the multicast timer expires at a timing T5, the terminal device 110 may transmit UAI to notify the network device 120 of a preference on multicast reception in an inactive or idle state. Upon transmission of the UAI, the terminal device 110 may start the RRC release timer and disable the multicast timer.

As shown in FIG. 4A, during running of the RRC release timer, the terminal device 110 does not receive a RRC release message. Upon expiry of the RRC release timer, the terminal device 110 may enable the multicast timer again and re-evaluate whether to enter the inactive or idle state to receive multicast service. It can be seen that the terminal device 110 is always in the connected state in this example.

FIG. 4B illustrates a schematic diagram 400B illustrating another example data transmission according to embodiments of the present disclosure. As shown in FIG. 4B, at a timing T6, the network device 120 may configure the terminal device 110 in a connected state with a multicast timer (Mtimer) of 10 s and a RRC release timer (Rtimer) of 5 s. Upon reception of multicast data from the network device 120 at a timing T6, the terminal device 110 may start the multicast timer. During running of the multicast timer, the terminal device 110 may further receive multicast data at a timing T7. In this case, the multicast timer continues running. During running of the multicast timer, the terminal device 110 may receive unicast data at a timing T8. In this case, the multicast timer is restarted. When the multicast timer expires at a timing T9, the terminal device 110 may transmit UAI to notify the network device 120 of a preference on multicast reception in an inactive or idle state. Upon transmission of the UAI, the terminal device 110 may start the RRC release timer and disable the multicast timer.

As shown in FIG. 4B, during running of the RRC release timer, the terminal device 110 receives a RRC release message indicating a multicast reception in an inactive or idle state at a timing T10. Upon reception of the RRC release message, the terminal device 110 may stop the RRC release timer and enter the inactive or idle state to continue receiving multicast service. It is to be understood that FIGS. 4A and 4B are merely examples and not intended for limiting the present disclosure.

In this way, a terminal device may precisely or reasonably enter an inactive or idle state to receive a multicast service. Further, the terminal device may receive a multicast configuration to make sure the service continuity upon cell reselection.

### Example of Entering Inactive or Idle State Based on Network Indication

In this embodiment, a terminal device may enter, based on an indication from the network, an inactive or idle state to continue receiving multicast service.

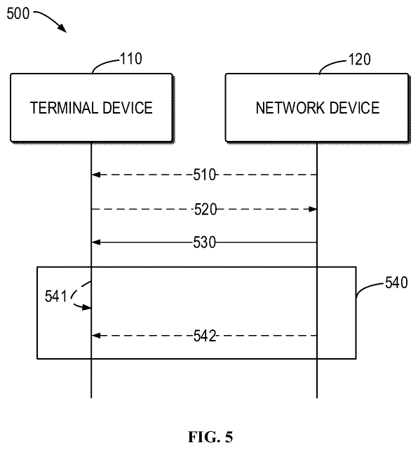

FIG. 5 illustrates a schematic diagram illustrating a process 500 of communication according to embodiments of the present disclosure. For the purpose of discussion, the process 500 will be described with reference to FIG. 1. The process 500 may involve the terminal device 110 and the network device 120 as illustrated in FIG. 1. It is to be understood that the steps and the order of the steps in FIG. 5 are merely for illustration, and not for limitation. For example, the order of the steps may be changed. Some of the steps may be omitted or any other suitable additional steps may be added. It is assumed that the terminal device 110 is served by the network device 120 and the terminal device 110 is in a connected state initially.

As shown in FIG. 5, the network device 120 may transmit 510, to the terminal device 110, an enquiry for a capability of the terminal device 110. For example, the network device 120 may transmit a UECapabilityEnquiry message or any other suitable messages. In response to the enquiry, the terminal device 110 may transmit 520, to the network device 120, the capability of the terminal device 110 for the multicast reception in the inactive or idle state. For example, the terminal device 110 may transmit a UECapabilityInformation message or any other suitable messages. In some embodiments, the capability of the terminal device 110 may indicate whether to support a multicast reception in an inactive or idle state. It is to be understood that the capability of the terminal device 110 may also comprise any other suitable information, and the present disclosure does not limit this aspect.

Continue to refer to FIG. 5, the terminal device 110 may receive 530, from the network device 120, a message (for convenience, also referred to as a fourth message herein) indicating a multicast reception in an inactive or idle state and comprising a multicast configuration for the multicast reception. For example, the fourth message may be a RRC release message. It is to be understood that any other suitable messages are also feasible, and the present disclosure does not limit this aspect. In some embodiments, the terminal device 110 may store and apply the multicast configuration.

In some embodiments, the multicast configuration may comprise an indication indicating the multicast reception in the inactive or idle state. For example, if the indication is configured with true, the terminal device 110 is indicated to receive a multicast service in an inactive or idle state.

In some embodiments, the multicast configuration may comprise a list of multicast configurations for cell reselection. For example, the list of multicast configurations may comprise C-RNTIs for different cells. As another example, the list of multicast configurations may comprise configurations on PDCP or RLC or MAC or PHY or BWP for different cells. For example, the MAC configuration list may comprise G-RNTI(s) for different cells.

In some embodiments, the multicast configuration may comprise a multicast frequency priority for cell reselection.

It is to be understood that the multicast configuration may also comprise any other suitable information. In some embodiments, the multicast configuration may further comprise a multicast allowed cell list indicating a first set of cells in which the multicast configuration is allowed to be used for the multicast reception. In some embodiments, the multicast configuration may further comprise a neighbor cell list indicating a second set of cells, the second set of cells being providing a multicast service that the terminal device is receiving.

Upon reception of the fourth message, the terminal device 110 may perform 540 a multicast reception in an inactive or idle state based on the multicast configuration. For example, the terminal device 110 may enter 541 the inactive or idle state and receive 542 a multicast service in the inactive or idle state.

In some embodiments, if the multicast configuration comprises an indication of the multicast reception in the inactive or idle state, the terminal device 110 may continue receiving multicast data in the inactive or idle state. In other words, the terminal device 110 may apply a multicast configuration used for a connected state to receive the multicast data in the inactive or idle state, without releasing the multicast configuration used for the connected state.

In some embodiments, if the multicast configuration comprises a list of multicast configurations for cell reselection and the terminal device 110 reselects to a cell, the terminal device 110 may apply a multicast configuration for the cell in the list of multicast configurations.

In some embodiments, if the multicast configuration comprises a multicast frequency priority for cell reselection, the terminal device 110 may store the multicast frequency priority and perform the cell reselection based on the multicast frequency priority when the terminal device 110 enters an inactive or idle state.

In some embodiments, if the multicast configuration comprises a multicast allowed cell list, the terminal device 110 may apply the multicast configuration for a cell in the multicast allowed cell list when the terminal device 110 reselects to the cell.

In some embodiments, if the multicast configuration comprises a neighbor cell list, the terminal device 110 may apply and store the neighbor cell list for the multicast reception.

In this way, a terminal device is enabled to enter an inactive or idle state in a more flexible way based on network implementation to receive a multicast service.

### Example of Entering Inactive or Idle State Based on Predefined Configuration

In this embodiment, a terminal device may enter, based on predefined configuration, an inactive or idle state to continue receiving multicast service.

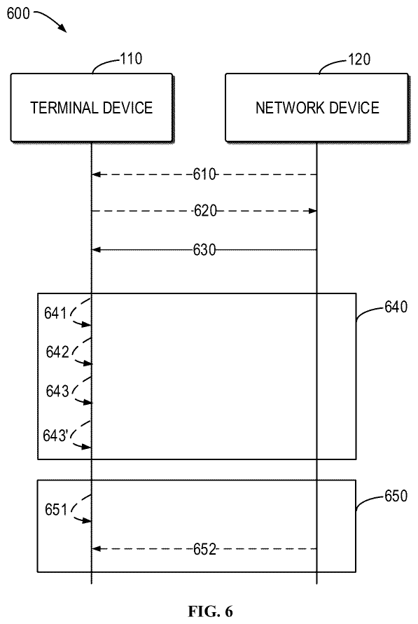

FIG. 6 illustrates a schematic diagram illustrating a process 600 of communication according to embodiments of the present disclosure. For the purpose of discussion, the process 600 will be described with reference to FIG. 1. The process 600 may involve the terminal device 110 and the network device 120 as illustrated in FIG. 1. It is to be understood that the steps and the order of the steps in FIG. 6 are merely for illustration, and not for limitation. For example, the order of the steps may be changed. Some of the steps may be omitted or any other suitable additional steps may be added. It is assumed that the terminal device 110 is served by the network device 120 and the terminal device 110 is in a connected state initially.

As shown in FIG. 6, the network device 120 may transmit 610, to the terminal device 110, an enquiry for a capability of the terminal device 110. For example, the network device 120 may transmit a UECapabilityEnquiry message or any other suitable messages. In response to the enquiry, the terminal device 110 may transmit 620, to the network device 120, the capability of the terminal device 110 for the multicast reception in the inactive or idle state. For example, the terminal device 110 may transmit a UECapabilityInformation message or any other suitable messages. In some embodiments, the capability of the terminal device 110 may indicate whether to support a multicast reception in an inactive or idle state. It is to be understood that the capability of the terminal device 110 may also comprise any other suitable information, and the present disclosure does not limit this aspect.

Continue to refer to FIG. 6, the terminal device 110 in a connected state may receive 630, from the network device 120, a message (for convenience, also referred to as a third message herein) comprising a multicast configuration for multicast reception of the terminal device 110 in an inactive or idle state. In some embodiments, the third message may be a RRC dedicated signaling. For example, the third message may be a RRC reconfiguration message, a RRC setup message or a RRC resume message. It is to be understood that any other suitable messages are also feasible, and the present disclosure does not limit this aspect. In this way, the multicast configuration for the multicast reception in an inactive or idle state may be provided to the terminal device in advance.

In some embodiments, the multicast configuration may comprise an indication indicating the multicast reception in the inactive or idle state. For example, if the indication is configured with true, the terminal device 110 is indicated to receive a multicast service in an inactive or idle state.

In some embodiments, the multicast configuration may comprise a list of multicast configurations for cell reselection. For example, the list of multicast configurations may comprise C-RNTIs for different cells. As another example, the list of multicast configurations may comprise configurations on packet data convergence protocol (PDCP) or radio link control (RLC) or MAC or physical (PHY) or bandwidth part (BWP) for different cells. For example, the MAC configuration list may comprise G-RNTI(s) for different cells.

In some embodiments, the multicast configuration may comprise a multicast frequency priority for cell reselection. In some embodiments, the multicast configuration may comprise a multicast allowed cell list indicating a first set of cells in which the multicast configuration is allowed to be used for the multicast reception. In some embodiments, the multicast configuration may comprise a neighbor cell list indicating a second set of cells, the second set of cells being providing a multicast service that the terminal device is receiving. It is to be understood that the multicast configuration may also comprise any other suitable information.

Continue to refer to FIG. 6, the terminal device 110 may determine 640 whether to perform a multicast reception in an inactive or idle state. In some embodiments, the terminal device 110 may determine whether to perform the multicast reception in the inactive or idle state based on the multicast timer.

In some embodiments, the network device 120 may configure the multicast timer to the terminal device 110 by a RRC dedicated signaling. In some embodiments, the network device 120 may configure the multicast timer in a SIB. In some embodiments, the multicast timer may be predefined.

In some embodiments, if multicast data is received and the multicast timer is not running, the terminal device 110 may start 641 the multicast timer. For example, if any MAC entity receives a MAC SDU for MTCH logical channel for multicast service and if the multicast timer is not running, the terminal device 110 may start the multicast timer.

In some embodiments, if unicast data is received, the terminal device 110 may restart 642 the multicast timer. For example, if any MAC entity receives a MAC SDU for DTCH, DCCH, or CCCH logical channel, the terminal device 110 may restart the multicast timer. In some alternative or additional embodiments, if unicast data is transmitted, the terminal device 110 may restart the multicast timer. For example, if any MAC entity transmits a MAC SDU for DTCH, DCCH, or CCCH logical channel, the terminal device 110 may restart the multicast timer.

In some embodiments, if the multicast timer expires, the terminal device 110 may determine 643 that the terminal device 110 is to perform the multicast reception in the inactive or idle state. For example, if the multicast timer expires, the MAC layer of the terminal device 110 may indicate the expiry of the multicast timer to an upper layer (e.g., RRC layer) of the terminal device 110. In some alternative embodiments, if the terminal device 110 is to enter the inactive or idle state to perform the multicast reception and the multicast timer is not running, the terminal device 110 may determine 643′ that the terminal device 110 is to perform the multicast reception in the inactive or idle state.

Upon determination that the terminal device 110 is to perform a multicast reception in an inactive or idle state, the terminal device 110 may perform 650 a multicast reception in an inactive or idle state based on the multicast configuration. For example, the terminal device may enter 651 the inactive or idle state and receive 652 a multicast service in the inactive or idle state.

In some embodiments, if the multicast configuration comprises an indication of the multicast reception in the inactive or idle state, the terminal device 110 may continue receiving multicast data in the inactive or idle state. In other words, the terminal device 110 may apply a multicast configuration used for a connected state to receive the multicast data in the inactive or idle state, without releasing the multicast configuration used for the connected state.

In some embodiments, if the multicast configuration comprises a list of multicast configurations for cell reselection and the terminal device 110 reselects to a cell (for convenience, also referred to as a first cell herein), the terminal device 110 may apply a multicast configuration for the first cell in the list of multicast configurations.

In some embodiments, if the multicast configuration comprises a multicast frequency priority for cell reselection, the terminal device 110 may store the multicast frequency priority and perform the cell reselection based on the multicast frequency priority when the terminal device 110 enters an inactive or idle state.

In some embodiments, if the multicast configuration comprises a multicast allowed cell list, the terminal device 110 may apply the multicast configuration for a cell (for convenience, also referred to as a second cell herein) in the multicast allowed cell list when the terminal device 110 reselects to the second cell.

In some embodiments, if the multicast configuration comprises a neighbor cell list, the terminal device 110 may apply and store the neighbor cell list for the multicast reception. In this way, a terminal device is enabled to enter an inactive or idle state in a more flexible and fast way based on a predefined multicast configuration to receive a multicast service.

### Example Implementation of Return to Connected State

Traditionally, when a terminal device is receiving a multicast service in an inactive or idle state, the terminal device will monitor a multicast paging in the inactive or idle state. When the terminal device is indicated by a multicast paging to receive the multicast service in a connected state, the terminal device has to perform a random access procedure to fallback to the connected state.

In view of this, embodiments of the present disclosure provide a solution for determining whether to enter a connected state for multicast reception so as to solve the above and other potential issues.

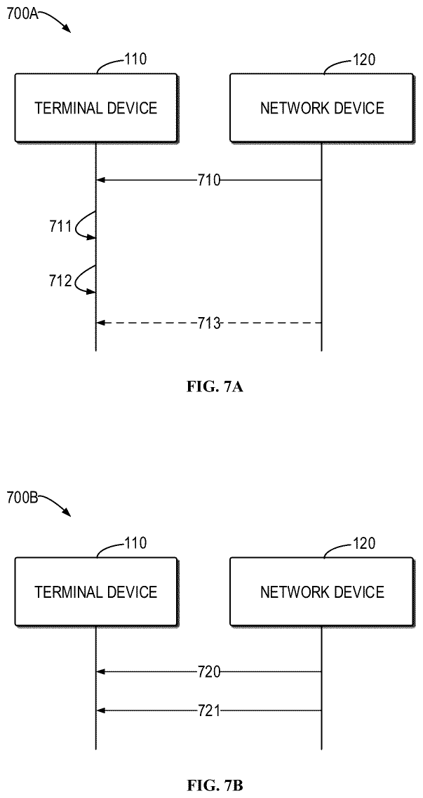

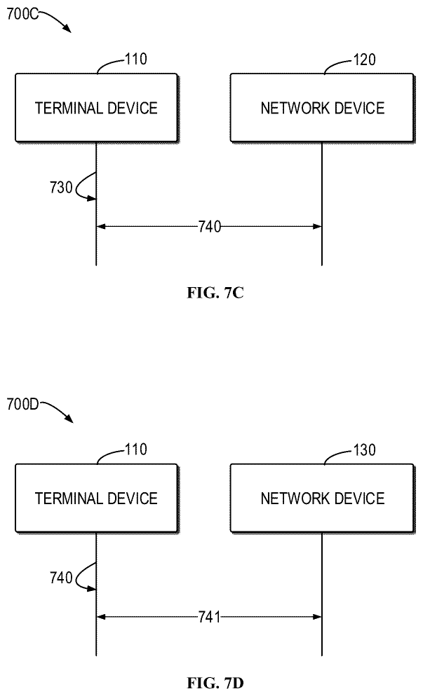

FIG. 7A a schematic diagram illustrating a process 700A of communication for skipping a multicast paging according to embodiments of the present disclosure. For the purpose of discussion, the process 700A will be described with reference to FIG. 1. The process 700A may involve the terminal device 110 and the network device 120 as illustrated in FIG. 1. It is to be understood that the steps and the order of the steps in FIG. 7A are merely for illustration, and not for limitation. For example, the order of the steps may be changed. Some of the steps may be omitted or any other suitable additional steps may be added. It is assumed that the terminal device 110 is served by the network device 120 and the terminal device 110 is in an inactive or idle state.

As shown in FIG. 7A, the network device 120 may transmit 710 a paging message to the terminal device 110. The paging message indicates a multicast reception in a connected state.

Upon reception of the paging message, the terminal device 110 may determine 711 whether the terminal device 110 is receiving a multicast session in an inactive or idle state and the multicast session is a multicast session that the terminal device 110 is interested in the paging message. For example, the terminal device 110 may determine whether the terminal device 110 has joined a MBS session indicated by a temporary mobile group identity (TMGI) included in a paging group list of the paging message and the terminal device 110 is receiving the MBS session in the inactive or idle state. If the terminal device 110 has joined the MBS session indicated by the TMGI included in the paging group list and the terminal device 110 is receiving the MBS session, the terminal device 110 may determine that the terminal device 110 is receiving the multicast session that the terminal device 110 is interested in the paging message.

If the terminal device 110 is receiving the multicast session that the terminal device 110 is interested in the paging message, the terminal device 110 may skip 712 the paging message. That is, the terminal device 110 continues the multicast reception in the inactive or idle state. For example, if the terminal device 110 in an inactive or idle state is receiving the MBS session indicated by the TMGI included in the paging group list, the terminal device 110 may ignore the paging group list within the paging message.

If the terminal device 110 is not receiving the multicast session that the terminal device is interested in the paging message, the terminal device 110 may perform 713 the multicast reception in the connected state. That is, the terminal device 110 may enter the connected state and receive the multicast session. For example, if the terminal device 110 has joined the MBS session indicated by the TMGI included in the paging group list but the terminal device 110 is not receiving the MBS session, the terminal device 110 may forward the TMGI to the upper layer. In this way, a terminal device in an idle state may perform a random access procedure to enter the connected state for multicast reception. As another example, if the terminal device 110 in an inactive state has joined the MBS session indicated by the TMGI included in the paging group list and the terminal device 110 is not receiving the MBS session, the terminal device 110 may initiate a RRC connection resume procedure.

In this way, a terminal device may avoid this unnecessary paging message for power saving. It is to be understood that the solution of FIG. 7A may be used separately or in combination with any of the solutions of FIGS. 3, 5 and 6.

Embodiments of the present disclosure also provide a solution for entering a connected state for multicast reception for solving the above and other potential issues. FIG. 7B a schematic diagram illustrating a process 700B of communication for entering a connected state for multicast reception according to embodiments of the present disclosure. For the purpose of discussion, the process 700B will be described with reference to FIG. 1. The process 700B may involve the terminal device 110 and the network device 120 as illustrated in FIG. 1. It is to be understood that the steps and the order of the steps in FIG. 7B are merely for illustration, and not for limitation. For example, the order of the steps may be changed. Some of the steps may be omitted or any other suitable additional steps may be added. It is assumed that the terminal device 110 is served by the network device 120 and the terminal device 110 is in an inactive or idle state.

As shown in FIG. 7B, the network device 120 may transmit 720 a paging message to the terminal device 110. The paging message indicates a multicast reception in a connected state. The paging message comprises a further multicast configuration for the multicast reception in the connected state.

In some embodiments, the further multicast configuration may comprise an indication indicating the multicast reception in the connected state. In some embodiments, the further multicast configuration may comprise a multicast configuration for the connected state. In some embodiments, the multicast configuration for the connected state may comprise a list of multicast configurations for cell reselection, a multicast frequency priority for cell reselection, a multicast allowed cell list indicating a set of cells in which the multicast configuration is allowed to be used for the multicast reception, or a neighbor cell list indicating a set of cells that is providing a multicast service that the terminal device is receiving. It is to be understood that the multicast configuration for the connected state may also comprise any other suitable information and the present disclosure does not limit this aspect.

Upon reception of the paging message, the terminal device 110 may perform 721 the multicast reception in the connected state based on the further multicast configuration. In some embodiments, if the further multicast configuration comprises an indication indicating the multicast reception in the connected state, the terminal device 110 may enter the connected state, and perform the multicast reception in the connected state based on the multicast configuration used in the inactive or idle state.

In this way, when entering the connected state, the terminal device 110 may directly use the further multicast configuration immediately without waiting for a RRC reconfiguration from the network device 120. Thus, lower data reception latency may be achieved. It is to be understood that the solution of FIG. 7B may be used separately or in combination with any of the solutions of FIGS. 3, 5 and 6.

In some scenarios, a terminal device in an inactive or idle state may be in a bad signal channel. In this case, the terminal device may have some problems on multicast scheduling but there is no any feedback mechanism. In view of this, embodiments of the present disclosure provide a solution for entering a connected state for multicast reception to solve this issue and other potential issues.

FIG. 7C a schematic diagram illustrating another process 700C of communication for entering a connected state for multicast reception according to embodiments of the present disclosure. For the purpose of discussion, the process 700C will be described with reference to FIG. 1. The process 700C may involve the terminal device 110 and the network device 120 as illustrated in FIG. 1. It is to be understood that the steps and the order of the steps in FIG. 7C are merely for illustration, and not for limitation. For example, the order of the steps may be changed. Some of the steps may be omitted or any other suitable additional steps may be added. It is assumed that the terminal device 110 is served by the network device 120 and the terminal device 110 is in an inactive or idle state.

As shown in FIG. 7C, the terminal device 110 may determine 730 whether signal quality of a channel between the terminal device 110 and the network device 120 is below threshold quality.

In some embodiments, the terminal device 110 may determine whether reference signal receive power (RSRP) on the channel is below threshold power. If the RSRP on the channel is below the threshold power, the terminal device 110 may determine that the signal quality is below the threshold quality. In some embodiments, the threshold power may be configured by system information. In some embodiments, the threshold power may be configured by a RRC dedicated signal. In some embodiments, the threshold power may be predefined. Alternatively, the terminal device 110 may determine whether reference signal receive quality (RSRQ) on the channel is below a threshold. If the RSRQ on the channel is below the threshold, the terminal device 110 may determine that the signal quality is below the threshold quality. In some embodiments, the threshold may be configured by system information. In some embodiments, the threshold may be configured by a RRC dedicated signal. In some embodiments, the threshold may be predefined.

In some alternative embodiments, the terminal device 110 may determine whether a signal receive level (for example, Srxlev) is below a threshold level. If the signal receive level is below the threshold level, the terminal device 110 may determine that the signal quality is below the threshold quality. In other words, measurement rules for cell reselection may be reused.

In some alternative embodiments, the terminal device 110 may determine whether a non-at-cell-edge criterion is fulfilled. If the non-at-cell-edge criterion is unfulfilled, the terminal device 110 may determine that the signal quality is below the threshold quality. In other words, the non-at-cell-edge criterion may be reused.

Continue to refer to FIG. 7C, if the signal quality is below the threshold quality, the terminal device 110 may initiate 740 a random access to enter a connected state with the network device 120.

In this way, the network may modify a configuration for a terminal device in a connected state to ensure a better service quality. It is to be understood that the solution of FIG. 7C may be used separately or in combination with any of the solutions of FIGS. 3, 5 and 6.

In some scenarios, a terminal device in the inactive or idle state may reselect to a cell. In this case, a scheduling for multicast reception in the inactive or idle state may become an issue and how to get a multicast configuration for the cell may also to be addressed. Embodiments of the present disclosure provide a solution for entering a connected state for multicast reception so as to solve the above and other potential issues.

FIG. 7D a schematic diagram illustrating still another process 700D of communication for entering a connected state for multicast reception according to embodiments of the present disclosure. For the purpose of discussion, the process 700D will be described with reference to FIG. 1. The process 700D may involve the terminal device 110 and the network device 120 as illustrated in FIG. 1. It is to be understood that the steps and the order of the steps in FIG. 7D are merely for illustration, and not for limitation. For example, the order of the steps may be changed. Some of the steps may be omitted or any other suitable additional steps may be added. It is assumed that the terminal device 110 is served by the network device 120 and the terminal device 110 is in an inactive or idle state.

As shown in FIG. 7D, the terminal device 110 may determine 740 whether a cell reselection to a cell (for convenience, also referred to as a third cell herein, and for example, the cell 131 of the network device 130) occurs. If the cell reselection occurs, the terminal device 110 may initiate 741 a random access to the cell 131 for the multicast reception.

In some embodiments, if the terminal device 110 is receiving a multicast service but is not configured with a multicast configuration for the cell 131, the terminal device 110 may initiate the random access for the multicast reception.

In some embodiments, if the terminal device 110 is receiving a multicast service, stored neighbor cell information for multicast comprises the cell 131 and the terminal device 110 has no multicast configuration for the cell 131, the terminal device 110 may initiate the random access for the multicast reception.

In some embodiments, if the terminal device 110 is receiving a multicast service and the terminal device 110 has no multicast configuration for the cell 131, the terminal device 110 may determine whether one of multicast sessions that the terminal device 110 is receiving matches a multicast session indicated in a list of multicast sessions broadcasted by the cell 131. If the one of multicast sessions that the terminal device is receiving matches the multicast session indicated in the list, the terminal device 110 may initiate the random access for the multicast reception. In this embodiment, the list of multicast sessions may be broadcasted by the cell 131 in system information. The list provides which multicast session is doing in the cell 131. In some embodiments, the list may indicate a TMGI associated with each of the multicast sessions.

In this way, a mechanism for multicast reception during cell reselection is specified and thus a terminal device may be ensured to receive a multicast service even when a cell reselection occurs. It is to be understood that the solution of FIG. 7D may be used separately or in combination with any of the solutions of FIGS. 3, 5 and 6.

### Example Implementation of Methods

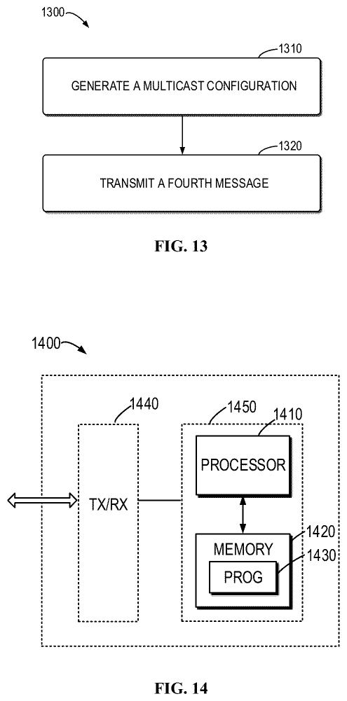

Corresponding to the above processes, embodiments of the present disclosure provide methods of communication implemented at a terminal device and a network device. These methods will be described below with reference to FIGS. 8 and 13.

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 determines whether the terminal device 110 is to perform a multicast reception in an inactive or idle state.

In some embodiments, if multicast data is received and a first timer is not running, the terminal device 110 may start the first timer. If unicast data is received or transmitted, the terminal device 110 may restart the first timer. In some embodiments, if the first timer expires, the terminal device 110 may determine that the terminal device 110 is to perform the multicast reception in the inactive or idle state. Alternatively, if the terminal device 110 is to enter the inactive or idle state to perform the multicast reception and that the first timer is not running, the terminal device 110 may determine that the terminal device 110 is to perform the multicast reception in the inactive or idle state.

If the terminal device 110 is to perform the multicast reception in the inactive or idle state, the method 800 proceeds to block 820. At block 820, the terminal device 110 transmits, to the network device 120, a first message comprising a preference on the multicast reception in the inactive or idle state.

At block 830, the terminal device 110 receives, from the network device 120, a second message indicating the multicast reception in the inactive or idle state and comprising a multicast configuration for the multicast reception.

In some embodiments, the multicast configuration may comprise at least one of the following: an indication indicating the multicast reception in the inactive or idle state, a list of multicast configurations for cell reselection, a multicast frequency priority for cell reselection, a multicast allowed cell list indicating a first set of cells in which the multicast configuration is allowed to be used for the multicast reception, ora neighbor cell list indicating a second set of cells, the second set of cells being providing a multicast service that the terminal device is receiving. In some embodiments, the list of multicast configurations may comprise at least one of the following: C-RNTIs for cells; or G-RNTIs for cells.

At block 840, the terminal device 110 performs the multicast reception in the inactive or idle state based on the multicast configuration.

In some embodiments, the terminal device 110 may start a second timer upon the transmission of the first message, and disable a first timer started upon reception of multicast data. If the second timer expires and the second message is not received, the terminal device 110 may enable the first timer. In some embodiments, the terminal device 110 may stop the second timer upon the reception of the second message.

In some embodiments, if the multicast configuration comprises an indication of the multicast reception in the inactive or idle state, the terminal device 110 may continue receiving multicast data in the inactive or idle state. In some embodiments, if the multicast configuration comprises a list of multicast configurations for cell reselection and the terminal device reselects to a first cell, the terminal device 110 may apply a multicast configuration for the first cell in the list of multicast configurations. In some embodiments, if the multicast configuration comprises a multicast frequency priority for cell reselection, the terminal device 110 may perform the cell reselection based on the multicast frequency priority. In some embodiments, if the multicast configuration comprises a multicast allowed cell list, the terminal device 110 may apply the multicast configuration for a second cell in the multicast allowed cell list when the terminal device 110 reselects to the second cell. In some embodiments, if the multicast configuration comprises a neighbor cell list, the terminal device 110 may apply and storing the neighbor cell list for the multicast reception.

In some embodiments, the terminal device 110 may receive, from the network device 120, an enquiry for a capability of the terminal device 110, and transmit, to the network device 120, the capability of the terminal device 110 for the multicast reception in the inactive or idle state.

In some embodiments, the terminal device 110 may receive a paging message from the network device 120, the paging message indicating a multicast reception in a connected state. If the terminal device 110 is receiving a multicast session in the inactive or idle state and the multicast session is a multicast session that the terminal device 110 is interested in the paging message, the terminal device 110 may skip the paging message. In some embodiments, if the terminal device 110 is not receiving the multicast session in the inactive or idle state and the multicast session is a multicast session that the terminal device is interested in the paging message, the terminal device 110 may perform the multicast reception in the connected state.

In some embodiments, the terminal device 110 may receive a paging message from the network device, the paging message indicating a multicast reception in a connected state and comprising a further multicast configuration for the multicast reception in the connected state, and perform the multicast reception in the connected state based on the further multicast configuration. In some embodiments, the further multicast configuration comprises at least one of the following: an indication indicating the multicast reception in the connected state; and a multicast configuration for the connected state. In some embodiments, if the further multicast configuration comprises an indication indicating the multicast reception in the connected state, the terminal device 110 may enter the connected state, and perform the multicast reception in the connected state based on the multicast configuration in the inactive or idle state.

In some embodiments, the terminal device 110 may determine whether signal quality of a channel between the terminal device and the network device is below threshold quality. In some embodiments, the terminal device 110 may determine whether a signal receive level is below a threshold level. If the signal receive level is below the threshold level, the terminal device 110 may determine that the signal quality is below the threshold quality. In some embodiments, the terminal device 110 may determine whether a non-at-cell-edge criterion is fulfilled. If the non-at-cell-edge criterion is unfulfilled, the terminal device 110 may determine that the signal quality is below the threshold quality. In some embodiments, if the signal quality is below the threshold quality, the terminal device 110 may initiate a random access to enter a connected state with the network device 120.

In some embodiments, if a cell reselection to a third cell occurs, the terminal device 110 may initiate a random access to the third cell for the multicast reception. In some embodiments, if the terminal device 110 is receiving a multicast service but is not configured with the multicast configuration, the terminal device 110 may initiate the random access for the multicast reception. In some embodiments, if the terminal device 110 is receiving a multicast service, stored neighbor cell information for multicast comprises the third cell and the terminal device 110 has no multicast configuration for the third cell, the terminal device 110 may initiate the random access for the multicast reception.

In some embodiments, if the terminal device 110 is receiving a multicast service and the terminal device has no multicast configuration for the third cell, the terminal device 110 may determine whether one of multicast sessions that the terminal device is receiving matches a multicast session indicated in a list of multicast sessions broadcasted by the third cell. If the one of multicast sessions that the terminal device is receiving matches the multicast session indicated in the list, the terminal device 110 may initiate the random access for the multicast reception.

With the method 800, a terminal device may precisely or reasonably enter an inactive or idle state to receive a multicast service. Further, the terminal device may receive a multicast configuration to make sure the service continuity upon cell reselection.

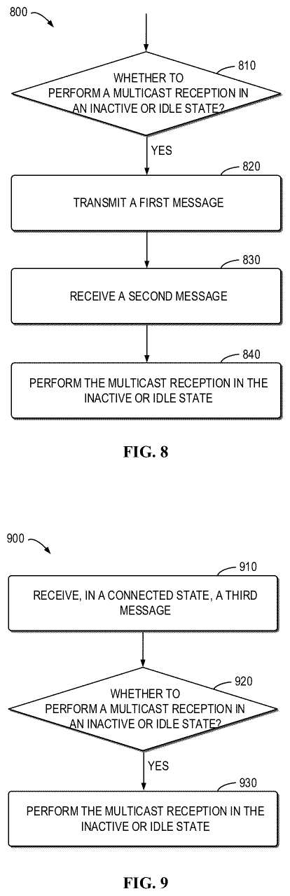

FIG. 9 illustrates another example method 900 of communication implemented at a terminal device in accordance with some embodiments of the present disclosure. For example, the method 900 may be performed at the terminal device 110 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the terminal device 110 in a connected state receives, from the network device 120, a third message comprising a multicast configuration for multicast reception of the terminal device in an inactive or idle state.

In some embodiments, the multicast configuration may comprise at least one of the following: an indication indicating the multicast reception in the inactive or idle state, a list of multicast configurations for cell reselection, a multicast frequency priority for cell reselection, a multicast allowed cell list indicating a first set of cells in which the multicast configuration is allowed to be used for the multicast reception, ora neighbor cell list indicating a second set of cells, the second set of cells being providing a multicast service that the terminal device is receiving. In some embodiments, the list of multicast configurations may comprise at least one of the following: C-RNTIs for cells; or G-RNTIs for cells.

At block 920, the terminal device 110 determines whether the terminal device 110 is to perform a multicast reception in an inactive or idle state.

In some embodiments, if multicast data is received and a first timer is not running, the terminal device 110 may start the first timer. If unicast data is received or transmitted, the terminal device 110 may restart the first timer. In some embodiments, if the first timer expires, the terminal device 110 may determine that the terminal device 110 is to perform the multicast reception in the inactive or idle state. Alternatively, if the terminal device 110 is to enter the inactive or idle state to perform the multicast reception and that the first timer is not running, the terminal device 110 may determine that the terminal device 110 is to perform the multicast reception in the inactive or idle state.

If the terminal device 110 is to perform the multicast reception in the inactive or idle state, the method 900 proceeds to block 930. At block 930, the terminal device 110 performs the multicast reception in the inactive or idle state based on the multicast configuration.

In some embodiments, if the multicast configuration comprises an indication of the multicast reception in the inactive or idle state, the terminal device 110 may continue receiving multicast data in the inactive or idle state. In some embodiments, if the multicast configuration comprises a list of multicast configurations for cell reselection and the terminal device reselects to a first cell, the terminal device 110 may apply a multicast configuration for the first cell in the list of multicast configurations. In some embodiments, if the multicast configuration comprises a multicast frequency priority for cell reselection, the terminal device 110 may perform the cell reselection based on the multicast frequency priority. In some embodiments, if the multicast configuration comprises a multicast allowed cell list, the terminal device 110 may apply the multicast configuration for a second cell in the multicast allowed cell list when the terminal device 110 reselects to the second cell. In some embodiments, if the multicast configuration comprises a neighbor cell list, the terminal device 110 may apply and storing the neighbor cell list for the multicast reception.

In some embodiments, the terminal device 110 may receive, from the network device 120, an enquiry for a capability of the terminal device 110, and transmit, to the network device 120, the capability of the terminal device 110 for the multicast reception in the inactive or idle state.

In some embodiments, the terminal device 110 may receive a paging message from the network device 120, the paging message indicating a multicast reception in a connected state. If the terminal device 110 is receiving a multicast session in the inactive or idle state and the multicast session is a multicast session that the terminal device 110 is interested in the paging message, the terminal device 110 may skip the paging message. In some embodiments, if the terminal device 110 is not receiving the multicast session in the inactive or idle state and the multicast session is a multicast session that the terminal device is interested in the paging message, the terminal device 110 may perform the multicast reception in the connected state.

In some embodiments, the terminal device 110 may receive a paging message from the network device, the paging message indicating a multicast reception in a connected state and comprising a further multicast configuration for the multicast reception in the connected state, and perform the multicast reception in the connected state based on the further multicast configuration. In some embodiments, the further multicast configuration comprises at least one of the following: an indication indicating the multicast reception in the connected state; and a multicast configuration for the connected state. In some embodiments, if the further multicast configuration comprises an indication indicating the multicast reception in the connected state, the terminal device 110 may enter the connected state, and perform the multicast reception in the connected state based on the multicast configuration in the inactive or idle state.

In some embodiments, the terminal device 110 may determine whether signal quality of a channel between the terminal device and the network device is below threshold quality. In some embodiments, the terminal device 110 may determine whether a signal receive level is below a threshold level. If the signal receive level is below the threshold level, the terminal device 110 may determine that the signal quality is below the threshold quality. In some embodiments, the terminal device 110 may determine whether a non-at-cell-edge criterion is fulfilled. If the non-at-cell-edge criterion is unfulfilled, the terminal device 110 may determine that the signal quality is below the threshold quality. In some embodiments, if the signal quality is below the threshold quality, the terminal device 110 may initiate a random access to enter a connected state with the network device 120.

In some embodiments, if a cell reselection to a third cell occurs, the terminal device 110 may initiate a random access to the third cell for the multicast reception. In some embodiments, if the terminal device 110 is receiving a multicast service but is not configured with the multicast configuration, the terminal device 110 may initiate the random access for the multicast reception. In some embodiments, if the terminal device 110 is receiving a multicast service, stored neighbor cell information for multicast comprises the third cell and the terminal device 110 has no multicast configuration for the third cell, the terminal device 110 may initiate the random access for the multicast reception.

In some embodiments, if the terminal device 110 is receiving a multicast service and the terminal device has no multicast configuration for the third cell, the terminal device 110 may determine whether one of multicast sessions that the terminal device is receiving matches a multicast session indicated in a list of multicast sessions broadcasted by the third cell. If the one of multicast sessions that the terminal device is receiving matches the multicast session indicated in the list, the terminal device 110 may initiate the random access for the multicast reception.

With the method 900, a terminal device is enabled to enter an inactive or idle state in a more flexible way based on network implementation to receive a multicast service.

FIG. 10 illustrates still another example method 1000 of communication implemented at a terminal device in accordance with some embodiments of the present disclosure. For example, the method 1000 may be performed at the terminal device 120 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the terminal device 110 receives, from the network device 120, a fourth message indicating a multicast reception in an inactive or idle state and comprising a multicast configuration for the multicast reception, the multicast configuration comprising at least one of the following: an indication of the multicast reception in the inactive or idle state, a list of multicast configurations specific to the terminal device 110 for cell reselection, or a multicast frequency priority for cell reselection. In some embodiments, the list of multicast configurations may comprise at least one of the following: cell-radio network temporary identifiers for cells; or group-radio network temporary identifiers for cells.

At block 1020, the terminal device 110 performs the multicast reception in the inactive or idle state based on the multicast configuration.

In some embodiments, if the multicast configuration comprises an indication of the multicast reception in the inactive or idle state, the terminal device 110 may continue receiving multicast data in the inactive or idle state. In some embodiments, if the multicast configuration comprises a list of multicast configurations for cell reselection and the terminal device reselects to a first cell, the terminal device 110 may apply a multicast configuration for the first cell in the list of multicast configurations. In some embodiments, if the multicast configuration comprises a multicast frequency priority for cell reselection, the terminal device 110 may perform the cell reselection based on the multicast frequency priority. In some embodiments, if the multicast configuration comprises a multicast allowed cell list, the terminal device 110 may apply the multicast configuration for a second cell in the multicast allowed cell list when the terminal device 110 reselects to the second cell. In some embodiments, if the multicast configuration comprises a neighbor cell list, the terminal device 110 may apply and storing the neighbor cell list for the multicast reception.

In some embodiments, the terminal device 110 may receive, from the network device 120, an enquiry for a capability of the terminal device 110, and transmit, to the network device 120, the capability of the terminal device 110 for the multicast reception in the inactive or idle state.

In some embodiments, the terminal device 110 may receive a paging message from the network device 120, the paging message indicating a multicast reception in a connected state. If the terminal device 110 is receiving a multicast session in the inactive or idle state and the multicast session is a multicast session that the terminal device 110 is interested in the paging message, the terminal device 110 may skip the paging message. In some embodiments, if the terminal device 110 is not receiving the multicast session in the inactive or idle state and the multicast session is a multicast session that the terminal device is interested in the paging message, the terminal device 110 may perform the multicast reception in the connected state.

In some embodiments, the terminal device 110 may receive a paging message from the network device, the paging message indicating a multicast reception in a connected state and comprising a further multicast configuration for the multicast reception in the connected state, and perform the multicast reception in the connected state based on the further multicast configuration. In some embodiments, the further multicast configuration comprises at least one of the following: an indication indicating the multicast reception in the connected state; and a multicast configuration for the connected state. In some embodiments, if the further multicast configuration comprises an indication indicating the multicast reception in the connected state, the terminal device 110 may enter the connected state, and perform the multicast reception in the connected state based on the multicast configuration in the inactive or idle state.

In some embodiments, the terminal device 110 may determine whether signal quality of a channel between the terminal device and the network device is below threshold quality. In some embodiments, the terminal device 110 may determine whether a signal receive level is below a threshold level. If the signal receive level is below the threshold level, the terminal device 110 may determine that the signal quality is below the threshold quality. In some embodiments, the terminal device 110 may determine whether a non-at-cell-edge criterion is fulfilled. If the non-at-cell-edge criterion is unfulfilled, the terminal device 110 may determine that the signal quality is below the threshold quality. In some embodiments, if the signal quality is below the threshold quality, the terminal device 110 may initiate a random access to enter a connected state with the network device 120.

In some embodiments, if a cell reselection to a third cell occurs, the terminal device 110 may initiate a random access to the third cell for the multicast reception. In some embodiments, if the terminal device 110 is receiving a multicast service but is not configured with the multicast configuration, the terminal device 110 may initiate the random access for the multicast reception. In some embodiments, if the terminal device 110 is receiving a multicast service, stored neighbor cell information for multicast comprises the third cell and the terminal device 110 has no multicast configuration for the third cell, the terminal device 110 may initiate the random access for the multicast reception.

In some embodiments, if the terminal device 110 is receiving a multicast service and the terminal device has no multicast configuration for the third cell, the terminal device 110 may determine whether one of multicast sessions that the terminal device is receiving matches a multicast session indicated in a list of multicast sessions broadcasted by the third cell. If the one of multicast sessions that the terminal device is receiving matches the multicast session indicated in the list, the terminal device 110 may initiate the random access for the multicast reception.

With the method 1000, a terminal device is enabled to enter an inactive or idle state in a more flexible and fast way based on a predefined multicast configuration to receive a multicast service.

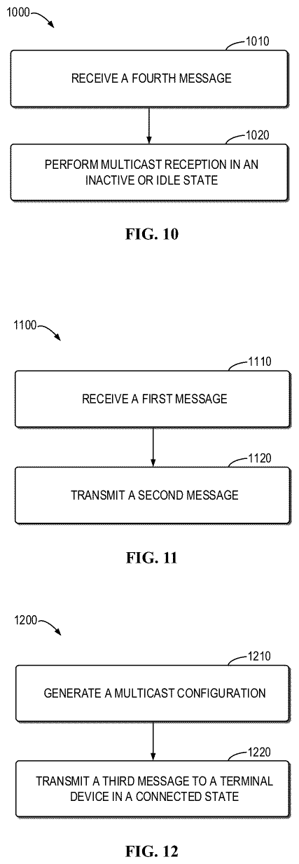

FIG. 11 illustrates an example method 1100 of communication implemented at a network device in accordance with some embodiments of the present disclosure. For example, the method 1000 may be performed at the network device 120 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1110, the network device 120 receives, from the terminal device 110, a first message comprising a preference on a multicast reception in an inactive or idle state.

At block 1120, the network device 120 transmits, to the terminal device 110, a second message indicating the multicast reception in the inactive or idle state and comprising a multicast configuration for the multicast reception.

In some embodiments, the multicast configuration may comprise at least one of the following: an indication indicating the multicast reception in the inactive or idle state, a list of multicast configurations for cell reselection, a multicast frequency priority for cell reselection, a multicast allowed cell list indicating a first set of cells in which the multicast configuration is allowed to be used for the multicast reception, ora neighbor cell list indicating a second set of cells, the second set of cells being providing a multicast service that the terminal device is receiving. In some embodiments, the list of multicast configurations may comprise at least one of the following: C-RNTIs for cells; or G-RNTIs for cells.

In some embodiments, the network device 120 may transmit, to the terminal device 110, an enquiry for a capability of the terminal device 110, and receive, from the terminal device 110, the capability of the terminal device 110 for the multicast reception in the inactive or idle state.

In some embodiments, the network device 120 may further transmit a paging message to the terminal device 110, the paging message indicating a multicast reception in a connected state and comprising a further multicast configuration for the multicast reception in the connected state. In some embodiments, the further multicast configuration comprises at least one of the following: an indication indicating the multicast reception in the connected state; and a multicast configuration for the connected state.

In some embodiments, the network device 120 may further broadcast a list of multicast sessions supported by the network device.

In this way, a network device may indicate a terminal device to perform a multicast reception in an inactive or idle state based on a request of the terminal device.

FIG. 12 illustrates another example method 1200 of communication implemented at a network device in accordance with some embodiments of the present disclosure. For example, the method 1200 may be performed at the network device 120 as shown in FIG. 1. For the purpose of discussion, in the following, the method 1200 will be described with reference to FIG. 1. It is to be understood that the method 1200 may include additional blocks not shown and/or may omit some blocks as shown, and the scope of the present disclosure is not limited in this regard.

At block 1210, the network device 120 generates a multicast configuration for multicast reception of a terminal device in an inactive or idle state.

At block 1220, the network device 120 transmits, to the terminal device 110 in a connected state, a third message comprising the multicast configuration.

In some embodiments, the multicast configuration may comprise at least one of the following: an indication indicating the multicast reception in the inactive or idle state, a list of multicast configurations for cell reselection, a multicast frequency priority for cell reselection, a multicast allowed cell list indicating a first set of cells in which the multicast configuration is allowed to be used for the multicast reception, or a neighbor cell list indicating a second set of cells, the second set of cells being providing a multicast service that the terminal device is receiving. In some embodiments, the list of multicast configurations may comprise at least one of the following: C-RNTIs for cells; or G-RNTIs for cells.

In some embodiments, the network device 120 may transmit, to the terminal device 110, an enquiry for a capability of the terminal device 110, and receive, from the terminal device 110, the capability of the terminal device 110 for the multicast reception in the inactive or idle state.

In some embodiments, the network device 120 may further transmit a paging message to the terminal device 110, the paging message indicating a multicast reception in a connected state and comprising a further multicast configuration for the multicast reception in the connected state. In some embodiments, the further multicast configuration comprises at least one of the following: an indication indicating the multicast reception in the connected state; and a multicast configuration for the connected state.

In some embodiments, the network device 120 may further broadcast a list of multicast sessions supported by the network device.

In this way, a network device may preconfigure, to a terminal device, a multicast configuration for a multicast reception in an inactive or idle state.

FIG. 13 illustrates still another example method 1300 of communication implemented at a network device in accordance with some embodiments of the present disclosure. For example, the method 1300 may be performed at the network device 120 as shown in FIG. 1. For the purpose of discussion, in the following, the method 1300 will be described with reference to FIG. 1. It is to be understood that the method 1300 may include additional blocks not shown and/or may omit some blocks as shown, and the scope of the present disclosure is not limited in this regard.

At block 1310, the network device 120 generates a multicast configuration for multicast reception of a terminal device in an inactive or idle state. The multicast configuration comprises at least one of the following: an indication of the multicast reception in the inactive or idle state, a list of multicast configurations specific to the terminal device for cell reselection, or a multicast frequency priority for cell reselection.

At block 1320, the network device 120 transmits, to the terminal device 110, a fourth message indicating the multicast reception of the terminal device 110 in the inactive or idle state and comprising the multicast configuration. In some embodiments, the list of multicast configurations may comprise at least one of the following: C-RNTIs for cells; or G-RNTIs for cells.

In some embodiments, the network device 120 may transmit, to the terminal device 110, an enquiry for a capability of the terminal device 110, and receive, from the terminal device 110, the capability of the terminal device 110 for the multicast reception in the inactive or idle state.

In some embodiments, the network device 120 may further transmit a paging message to the terminal device 110, the paging message indicating a multicast reception in a connected state and comprising a further multicast configuration for the multicast reception in the connected state. In some embodiments, the further multicast configuration comprises at least one of the following: an indication indicating the multicast reception in the connected state; and a multicast configuration for the connected state.

In some embodiments, the network device 120 may further broadcast a list of multicast sessions supported by the network device.

In this way, a network device may configure a multicast configuration for a multicast reception in an inactive or idle state while indicating the multicast reception.

### Example Implementation of Device and Apparatus

FIG. 14 is a simplified block diagram of a device 1400 that is suitable for implementing embodiments of the present disclosure. The device 1400 can be considered as a further example implementation of the terminal device 110 or the network device 120 as shown in FIG. 1. Accordingly, the device 1400 can be implemented at or as at least a part of the terminal device 110 or the network device 120.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1430 is assumed to include program instructions that, when executed by the associated processor 1410, enable the device 1400 to operate in accordance with the embodiments of the present disclosure, as discussed herein with reference to FIGS. 1 to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

In some embodiments, a terminal device comprises a circuitry configured to: in accordance with a determination that a terminal device is to perform a multicast reception in an inactive or idle state, transmit, to a network device, a first message comprising a preference on the multicast reception in the inactive or idle state; receive, from the network device, a second message indicating the multicast reception in the inactive or idle state and comprising a multicast configuration for the multicast reception; and perform the multicast reception in the inactive or idle state based on the multicast configuration.

In some embodiments, a terminal device comprises a circuitry configured to: receive, in a connected state and from a network device, a third message comprising a multicast configuration for multicast reception of the terminal device in an inactive or idle state; and in accordance with a determination that the terminal device is to perform the multicast reception in the inactive or idle state, perform the multicast reception in the inactive or idle state based on the multicast configuration.

In some embodiments, a terminal device comprises a circuitry configured to: receive, from a network device, a fourth message indicating a multicast reception in an inactive or idle state and comprising a multicast configuration for the multicast reception, the multicast configuration comprising at least one of the following: an indication of the multicast reception in the inactive or idle state, a list of multicast configurations specific to the terminal device for cell reselection, or a multicast frequency priority for cell reselection; and perform the multicast reception in the inactive or idle state based on the multicast configuration.

In some embodiments, a network device comprises a circuitry configured to: receive, from a terminal device, a first message comprising a preference on a multicast reception in an inactive or idle state; and transmit, to the terminal device, a second message indicating the multicast reception in the inactive or idle state and comprising a multicast configuration for the multicast reception.

In some embodiments, a network device comprises a circuitry configured to: generate a multicast configuration for multicast reception of a terminal device in an inactive or idle state; and transmit, to the terminal device in a connected state, a third message comprising the multicast configuration.

In some embodiments, a network device comprises a circuitry configured to: generate a multicast configuration for a multicast reception of a terminal device in an inactive or idle state, the multicast configuration comprising at least one of the following: an indication of the multicast reception in the inactive or idle state, a list of multicast configurations specific to the terminal device for cell reselection, or a multicast frequency priority for cell reselection; and transmit, to the terminal device, a fourth message indicating the multicast reception of the terminal device in the inactive or idle state and comprising the multicast configuration.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

Clause 1. A method of communication, comprising:
in accordance with a determination that a terminal device is to perform a multicast reception in an inactive or idle state, transmitting, at the terminal device and to a network device, a first message comprising a preference on the multicast reception in the inactive or idle state;
receiving, from the network device, a second message indicating the multicast reception in the inactive or idle state and comprising a multicast configuration for the multicast reception; and
performing the multicast reception in the inactive or idle state based on the multicast configuration.

Clause 2. A method of communication, comprising:
receiving, at a terminal device in a connected state and from a network device, a third message comprising a multicast configuration for multicast reception of the terminal device in an inactive or idle state; and
in accordance with a determination that the terminal device is to perform the multicast reception in the inactive or idle state, performing the multicast reception in the inactive or idle state based on the multicast configuration.

Clause 3. The method of Clause 1 or 2, further comprising:
in accordance with a determination that multicast data is received and a first timer is not running, starting the first timer;
in accordance with a determination that unicast data is received or transmitted, restarting the first timer; and
in accordance with a determination that the first timer expires, determining that the terminal device is to perform the multicast reception in the inactive or idle state.

Clause 4. The method of Clause 1 or 2, further comprising:
in accordance with a determination that multicast data is received and a first timer is not running, starting the first timer;
in accordance with a determination that unicast data is received or transmitted, restarting the first timer; and
in accordance with a determination that the terminal device is to enter the inactive or idle state to perform the multicast reception and that the first timer is not running, determining that the terminal device is to perform the multicast reception in the inactive or idle state.

Clause 5. The method of Clause 1 or 2, wherein the multicast configuration comprises at least one of the following:
an indication indicating the multicast reception in the inactive or idle state,
a list of multicast configurations for cell reselection,
a multicast frequency priority for cell reselection,
a multicast allowed cell list indicating a first set of cells in which the multicast configuration is allowed to be used for the multicast reception, or
a neighbor cell list indicating a second set of cells, the second set of cells being providing a multicast service that the terminal device is receiving.

Clause 6. The method of Clause 5, wherein the list of multicast configurations comprises at least one of the following:
cell-radio network temporary identifiers for cells; or
group-radio network temporary identifiers for cells.

Clause 7. The method of Clause 1, further comprising:
starting a second timer upon the transmission of the first message;
disabling a first timer started upon reception of multicast data; and
in accordance with a determination that the second timer expires and the second message is not received, enabling the first timer.

Clause 8. The method of Clause 7, further comprising:
stopping the second timer upon the reception of the second message.

Clause 9. A method of communication, comprising:
receiving, at a terminal device and from a network device, a fourth message indicating a multicast reception in an inactive or idle state and comprising a multicast configuration for the multicast reception, the multicast configuration comprising at least one of the following: an indication of the multicast reception in the inactive or idle state, a list of multicast configurations specific to the terminal device for cell reselection, or a multicast frequency priority for cell reselection; and
performing the multicast reception in the inactive or idle state based on the multicast configuration.

Clause 10. The method of Clause 9, wherein the list of multicast configurations comprises at least one of the following:
cell-radio network temporary identifiers for cells; or
group-radio network temporary identifiers for cells.

Clause 11. The method of Clause 1, 2 or 9, wherein performing the multicast reception comprises:
in accordance with a determination that the multicast configuration comprises an indication of the multicast reception in the inactive or idle state, continuing receiving multicast data in the inactive or idle state;
in accordance with a determination that the multicast configuration comprises a list of multicast configurations for cell reselection and the terminal device reselects to a first cell, applying a multicast configuration for the first cell in the list of multicast configurations;
in accordance with a determination that the multicast configuration comprises a multicast frequency priority for cell reselection, performing the cell reselection based on the multicast frequency priority;
in accordance with a determination that the multicast configuration comprises a multicast allowed cell list, applying the multicast configuration for a second cell in the multicast allowed cell list when the terminal device reselects to the second cell; or
in accordance with a determination that the multicast configuration comprises a neighbor cell list, applying and storing the neighbor cell list for the multicast reception.

Clause 12. The method of Clause 1, 2 or 9, further comprising:
receiving, from the network device, an enquiry for a capability of the terminal device; and
transmitting, to the network device, the capability of the terminal device for the multicast reception in the inactive or idle state.

Clause 13. The method of Clause 1, 2 or 9, further comprising:
receiving a paging message from the network device, the paging message indicating a multicast reception in a connected state; and
in accordance with a determination that the terminal device is receiving a multicast session in the inactive or idle state and the multicast session is a multicast session that the terminal device is interested in the paging message, skipping the paging message.

Clause 14. The method of Clause 13, further comprising:
in accordance with a determination that the terminal device is not receiving the multicast session in the inactive or idle state and the multicast session is a multicast session that the terminal device is interested in the paging message, performing the multicast reception in the connected state.

Clause 15. The method of Clause 1, 2 or 9, further comprising:
receiving a paging message from the network device, the paging message indicating a multicast reception in a connected state and comprising a further multicast configuration for the multicast reception in the connected state; and
performing the multicast reception in the connected state based on the further multicast configuration.

Clause 16. The method of Clause 15, wherein the further multicast configuration comprises at least one of the following:
an indication indicating the multicast reception in the connected state; and
a multicast configuration for the connected state.

Clause 17. The method of Clause 15, wherein performing the multicast reception in the connected state comprises:
in accordance with a determination that the further multicast configuration comprises an indication indicating the multicast reception in the connected state,
entering the connected state; and
performing the multicast reception in the connected state based on the multicast configuration in the inactive or idle state.

Clause 18. The method of Clause 1, 2 or 9, further comprising:
determining whether signal quality of a channel between the terminal device and the network device is below threshold quality; and
in accordance with a determination that the signal quality is below the threshold quality, initiating a random access to enter a connected state with the network device.

Clause 19. The method of Clause 18, wherein determining whether the signal quality is below the threshold quality comprises:
determining whether a signal receive level is below a threshold level; and
in accordance with a determination that the signal receive level is below the threshold level, determining that the signal quality is below the threshold quality.

Clause 20. The method of Clause 18, wherein determining whether the signal quality is below the threshold quality comprises:
determining whether a non-at-cell-edge criterion is fulfilled; and
in accordance with a determination that the non-at-cell-edge criterion is unfulfilled, determining that the signal quality is below the threshold quality.

Clause 21. The method of Clause 1, 2 or 9, further comprising:
in accordance with a determination that a cell reselection to a third cell occurs, initiating a random access to the third cell for the multicast reception.

Clause 22. The method of Clause 21, wherein initiating the random access comprises:
in accordance with a determination that the terminal device is receiving a multicast service but is not configured with the multicast configuration, initiating the random access for the multicast reception.

Clause 23. The method of Clause 21, wherein initiating the random access comprises:
in accordance with a determination that the terminal device is receiving a multicast service, stored neighbor cell information for multicast comprises the third cell and the terminal device has no multicast configuration for the third cell, initiating the random access for the multicast reception.

Clause 24. The method of Clause 21, wherein initiating the random access comprises:
in accordance with a determination that the terminal device is receiving a multicast service and the terminal device has no multicast configuration for the third cell, determining whether one of multicast sessions that the terminal device is receiving matches a multicast session indicated in a list of multicast sessions broadcasted by the third cell, and
in accordance with a determination that the one of multicast sessions that the terminal device is receiving matches the multicast session indicated in the list, initiating the random access for the multicast reception.

Clause 25. A method of communication, comprising:
receiving, at a network device and from a terminal device, a first message comprising a preference on a multicast reception in an inactive or idle state; and
transmitting, to the terminal device, a second message indicating the multicast reception in the inactive or idle state and comprising a multicast configuration for the multicast reception.

Clause 26. A method of communication, comprising:
generating, at a network device, a multicast configuration for multicast reception of a terminal device in an inactive or idle state; and
transmitting, to the terminal device in a connected state, a third message comprising the multicast configuration.

Clause 27. The method of Clause 25 or 26, wherein the multicast configuration comprises at least one of the following:
an indication indicating the multicast reception in the inactive or idle state,
a list of multicast configurations for cell reselection,
a multicast frequency priority for cell reselection,
a multicast allowed cell list indicating a first set of cells in which the multicast configuration is allowed to be used for the multicast reception, or
a neighbor cell list indicating a second set of cells, the second set of cells being providing a multicast service that the terminal device is receiving.

Clause 28. The method of Clause 27, wherein the list of multicast configurations comprises at least one of the following:
cell-radio network temporary identifiers for cells; or
group-radio network temporary identifiers for cells.

Clause 29. A method of communication, comprising:
generating, at a network device, a multicast configuration for a multicast reception of a terminal device in an inactive or idle state, the multicast configuration comprising at least one of the following: an indication of the multicast reception in the inactive or idle state, a list of multicast configurations specific to the terminal device for cell reselection, or a multicast frequency priority for cell reselection; and
transmitting, to the terminal device, a fourth message indicating the multicast reception of the terminal device in the inactive or idle state and comprising the multicast configuration.

Clause 30. The method of Clause 29, wherein the list of multicast configurations comprises at least one of the following:
cell-radio network temporary identifiers for cells; or
group-radio network temporary identifiers for cells.

Clause 31. The method of Clause 25, 26 or 29, further comprising:
transmitting, to the terminal device, an enquiry for a capability of the terminal device; and
receiving, from the terminal device, the capability of the terminal device for the multicast reception in the inactive or idle state.

Clause 32. The method of Clause 25, 26 or 29, further comprising:
transmitting a paging message to the terminal device, the paging message indicating a multicast reception in a connected state and comprising a further multicast configuration for the multicast reception in the connected state.

Clause 33. The method of Clause 32, wherein the further multicast configuration comprises at least one of the following:
an indication indicating the multicast reception in the connected state; and
a multicast configuration for the connected state.

Clause 34. The method of Clause 25, 26 or 29, further comprising:
broadcasting a list of multicast sessions supported by the network device.

Clause 35. A terminal device comprising:
a processor configured to cause the terminal device to perform the method according to any of Clauses 1 to 24.

Clause 36. A network device comprising:
a processor configured to cause the network device perform the method according to any of Clauses 25 to 34.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method by a user equipment comprising:
receiving, from a network device, a message comprising a multicast configuration for multicast reception; and
initiating a random access for the multicast reception,
wherein the random access is initiated after cell reselection in a case where the user equipment is in an inactive state, or the random access is initiated in a case where the user equipment is in the inactive state and signal quality of a channel between the user equipment and the network device is below a threshold.

22. The method according to claim 21,
wherein the message is a Radio Resource Control (RRC) release message.

23. The method according to claim 21,
wherein the random access is initiated in a case where the multicast configuration is not available in a cell reselected in the cell reselection.

24. A user equipment comprising:
at least one memory; and
at least one hardware processor coupled to the at least one memory,
wherein the at least one hardware processor is configured to:
receive, from a network device, a message comprising a multicast configuration for multicast reception; and
initiate a random access for the multicast reception,
wherein the random access is initiated after cell reselection in a case where the user equipment is in an inactive state, or the random access is initiated in a case where the user equipment is in the inactive state and signal quality of a channel between the user equipment and the network device is below a threshold.
